(19) United States
(12) Patent Application Publication
(10) Pub. No.: US 2022/0140949 A1
(43) Pub. Date: May 5, 2022

(54) METHOD AND APPARATUS FOR HYBRID AUTOMATIC REPEAT REQUEST FEEDBACK IN COMMUNICATION SYSTEM

(71) Applicant: ELECTRONICS AND TELECOMMUNICATIONS RESEARCH INSTITUTE, Daejeon (KR)

(72) Inventor: Jung Bin KIM, Daejeon (KR)

(73) Assignee: ELECTRONICS AND TELECOMMUNICATIONS RESEARCH INSTITUTE, Daejeon (KR)

(21) Appl. No.: 17/517,174

(22) Filed: Nov. 2, 2021

(30) Foreign Application Priority Data
Nov. 3, 2020 (KR) 10-2020-0145560
Oct. 5, 2021 (KR) 10-2021-0131860

(51) Int. Cl. H04L 1/18; H04W 72/04; H04L 5/00

(52) U.S. Cl. CPC H04L 1/1812; H04L 5/0048; H04W 72/0413

(57) ABSTRACT

An operation method of a terminal in a communication system may comprise: receiving, from a base station, a higher layer message including first configuration information of a first HARQ process group and second configuration information of a second HARQ process group; receiving, from the base station, control information including an RV field including first information indicating one HARQ process group used for communication between the terminal and the base station among the first HARQ process group and the second HARQ process group, a HPN field including second information indicating a number of a HARQ process belonging to the one HARQ process group indicated by the first information, and resource allocation information; receiving data from the base station based on the resource allocation information; and determining whether to transmit a HARQ feedback for the data according to the first information included in the control information.

### CROSS-REFERENCE TO RELATED APPLICATIONS

This application claims priority to Korean Patent Applications No. 10-2020-0145560 filed on Nov. 3, 2020 and No. 10-2021-0131860 filed on Oct. 5, 2021 with the Korean Intellectual Property Office (KIPO), the entire contents of which are hereby incorporated by reference.

### BACKGROUND

### 1. Technical Field

The present disclosure relates to a technique for hybrid automatic repeat request (HARQ) feedback in a communication system, and more particularly, to a technique for independent HARQ feedback per HARQ process.

### 2. Related Art

The communication network (e.g., new radio (NR) communication network) using a higher frequency band (e.g., frequency band of 6 gigahertz (GHz) or above) than a frequency band (e.g., frequency band of 6 GHz or below) of the long term evolution (LTE) (or, LTE-A) is being considered for processing of soaring wireless data. The NR communication network may support not only a frequency band below 6 GHz but also a 6 GHz or higher frequency band, and may support various communication services and scenarios as compared to the LTE communication network. For example, usage scenarios of the NR communication network may include enhanced mobile broadband (eMBB), ultra-reliable low-latency communication (URLLC), massive machine type communication (mMTC), and the like.

The NR communication network may provide communication services to terminals located in a terrestrial environment. Recently, the demand for communication services for airplanes, drones, satellites, etc. located in a non-terrestrial environment as wells as in a terrestrial environment is increasing, and for this purpose, technologies for a non-terrestrial network (NTN) are being discussed. The NTN may be implemented based on the NR technologies. For example, in the NTN, communications between a satellite and a communication node located on the ground or a communication node (e.g., airplane, drone, etc.) located in the non-terrestrial environment may be performed based on the NR technologies. In the NTN, a satellite may perform functions of a base station in the NR communication network.

Meanwhile, when a communication distance between a base station and a terminal is increased and a round trip time (RTT) therebetween is greatly increased, there may occur a problem that it is difficult to expect smooth HARQ operations due to a limited number of HARQ processes and a limited size of a PDSCH-to-HARQ feedback timing indicator.

### SUMMARY

In order to solve the above-identified problems, exemplary embodiments of the present disclosure are directed to providing a method and an apparatus of supporting HARQ processes for feedback-support or non-feedback-support in a communication system.

According to an exemplary embodiment of the present disclosure for achieving the above-described objective, an operation method of a terminal in a communication system may comprise: receiving, from a base station, a higher layer message including first configuration information of a first hybrid automatic repeat request (HARQ) process group and second configuration information of a second HARQ process group; receiving, from the base station, control information including a redundancy version (RV) field including first information indicating one HARQ process group used for communication between the terminal and the base station among the first HARQ process group and the second HARQ process group, a HARQ process number (HPN) field including second information indicating a number of a HARQ process belonging to the one HARQ process group indicated by the first information, and resource allocation information; receiving data from the base station based on the resource allocation information; and determining whether to transmit a HARQ feedback for the data according to the first information included in the control information, wherein the first HARQ process group includes a plurality of type 1-HARQ processes for feedback-support, and the second HARQ process group includes a plurality of type 2-HARQ processes for non-feedback-support.

The first configuration information may include information on the first HARQ process group to which the plurality of type 1-HARQ processes belong, and HARQ process numbers set to the plurality of type 1-HARQ processes.

The second configuration information may include information on the second HARQ process group to which the plurality of type 2-HARQ processes belong, and HARQ process numbers set to the plurality of type 2-HARQ processes.

When the first information included in the RV field indicates the first HARQ process group, the HPN field may further include an extension value of a physical downlink shared channel (PDSCH)-to-HARQ feedback timing.

When the second information included in the HPN field indicates a number of one of the plurality of type 2-HARQ processes belonging to the second HARQ process group, the control information may further include a downlink assignment index (DAI) field and a PDSCH-to-HARQ feedback timing indicator field, and the DAI field and the PDSCH-to-HARQ feedback timing indicator field may be used for extension of HARQ processes.

The operation method may further comprise performing an operation of transmitting the HARQ feedback to the base station according to information indicated by the first information, wherein when the first information indicates the first HARQ process group, the operation of transmitting the HARQ feedback is performed, and when the first information indicates the second HARQ process group, the operation of transmitting the HARQ feedback is not performed.

According to another exemplary embodiment of the present disclosure for achieving the above-described objective, an operation method of a base station in a communication system may comprise: configuring a first hybrid automatic repeat request (HARQ) process group including a plurality of type 1-HARQ processes and a second HARQ process group including a plurality of type 2-HARQ processes; transmitting, to a terminal, a higher layer message including first configuration information of the first HARQ process group and second configuration information of the second HARQ process group; transmitting, to the terminal, control information including a redundancy version (RV) field including first information indicating one HARQ process group used for communication between the terminal and the base station among the first HARQ process group and the second HARQ process group, a HARQ process number (HPN) field including second information indicating a number of a HARQ process belonging to the one HARQ process group indicated by the first information, and resource allocation information; and transmitting data to the terminal based on the control information, wherein the first HARQ process group includes a plurality of type 1-HARQ processes for feedback-support, and the second HARQ process group includes a plurality of type 2-HARQ processes for non-feedback-support.

The first configuration information may include information on the first HARQ process group to which the plurality of type 1-HARQ processes belong, and HARQ process numbers set to the plurality of type 1-HARQ processes.

The second configuration information may include information on the second HARQ process group to which the plurality of type 2-HARQ processes belong, and HARQ process numbers set to the plurality of type 2-HARQ processes.

When the first information included in the RV field indicates the first HARQ process group, the HPN field may further include an extension value of a physical downlink shared channel (PDSCH)-to-HARQ feedback timing.

When the second information included in the HPN field indicates a number of one of the plurality of type 2-HARQ processes belonging to the second HARQ process group, the control information may further include a downlink assignment index (DAI) field and a PDSCH-to-HARQ feedback timing indicator field, and the DAI field and the PDSCH-to-HARQ feedback timing indicator field may be used for extension of HARQ processes.

The operation method may further comprise performing an operation of receiving the HARQ feedback for the data from the base station according to information indicated by the first information, wherein when the first information indicates the first HARQ process group, the operation of receiving the HARQ feedback is performed, and when the first information indicates the second HARQ process group, the operation of receiving the HARQ feedback is not performed.

According to yet another exemplary embodiment of the present disclosure for achieving the above-described objective, a terminal in a communication system may comprise: a processor; a memory electronically communicating with the processor; and instructions stored in the memory, wherein when executed by the processor, the instructions cause the terminal to: receive, from a base station, a higher layer message including first configuration information of a first hybrid automatic repeat request (HARQ) process group and second configuration information of a second HARQ process group; receive, from the base station, control information including a redundancy version (RV) field including first information indicating one HARQ process group used for communication between the terminal and the base station among the first HARQ process group and the second HARQ process group, a HARQ process number (HPN) field including second information indicating a number of a HARQ process belonging to the one HARQ process group indicated by the first information, and resource allocation information; receive data from the base station based on the resource allocation information; and determine whether to transmit a HARQ feedback for the data according to the first information included in the control information, wherein the first HARQ process group includes a plurality of type 1-HARQ processes for feedback-support, and the second HARQ process group includes a plurality of type 2-HARQ processes for non-feedback-support.

The first configuration information may include information on the first HARQ process group to which the plurality of type 1-HARQ processes belong, and HARQ process numbers set to the plurality of type 1-HARQ processes.

The second configuration information may include information on the second HARQ process group to which the plurality of type 2-HARQ processes belong, and HARQ process numbers set to the plurality of type 2-HARQ processes.

When the first information included in the RV field indicates the first HARQ process group, the HPN field may further include an extension value of a physical downlink shared channel (PDSCH)-to-HARQ feedback timing.

When the second information included in the HPN field indicates a number of one of the plurality of type 2-HARQ processes belonging to the second HARQ process group, the control information may further include a downlink assignment index (DAI) field and a PDSCH-to-HARQ feedback timing indicator field, and the DAI field and the PDSCH-to-HARQ feedback timing indicator field may be used for extension of HARQ processes.

The instructions may further cause the terminal to: perform an operation of transmitting the HARQ feedback to the base station according to information indicated by the first information, wherein when the first information indicates the first HARQ process group, the operation of transmitting the HARQ feedback is performed, and when the first information indicates the second HARQ process group, the operation of transmitting the HARQ feedback is not performed.

According to exemplary embodiments of the present disclosure, in a wireless communication system having a long RTT, a base station may divide HARQ processes into a HARQ process group for feedback-support and a HARQ process group for non-feedback-support, so that HARQ functions can be smoothly performed. Through this, the base station may extend a PDSCH-to-HARQ feedback timing or the number of HARQ processes. Accordingly, the spectral efficiency in the wireless communication system having a long RTT can be improved, and thus the performance of the communication system also can be improved.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3A is a conceptual diagram illustrating a first exemplary embodiment of HARQ processes for feedback-support or non-feedback-support in a communication system.

FIG. 3B is a conceptual diagram illustrating a second exemplary embodiment of HARQ processes for feedback-support or non-feedback-support in a communication system.

FIG. 4 is a flowchart illustrating a first exemplary embodiment of a feedback method in HARQ processes for feedback-support in a communication system.

FIG. 5 is a conceptual diagram illustrating a method of using resources in an HPN field in a communication system.

FIG. 6 is a flowchart illustrating a first exemplary embodiment of a feedback method in HARQ processes for non-feedback-support in a communication system.

FIG. 7 is a conceptual diagram illustrating a method of extending HARQ processes in a communication system.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

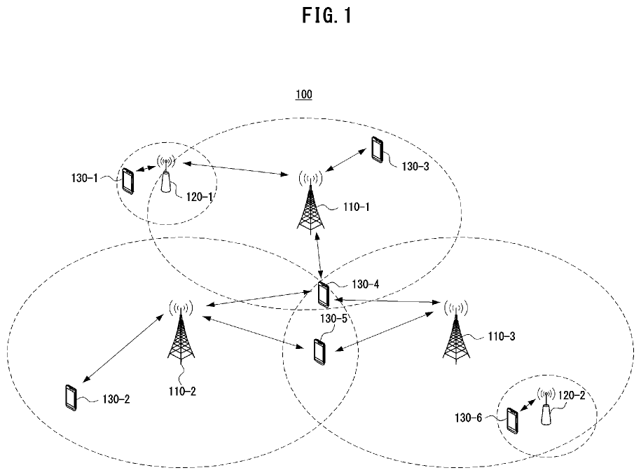

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 GHz or below, and the 5G communication may be performed in a frequency band of 6 GHz or above.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

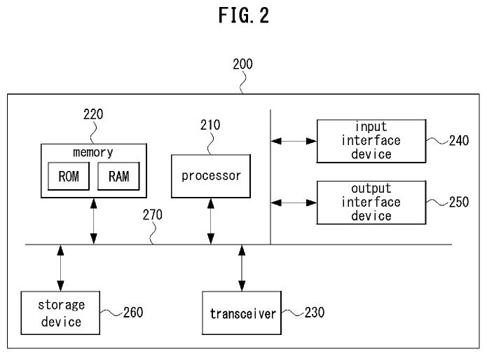

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, evolved Node-B (eNB), base transceiver station (BTS), radio base station, radio transceiver, access point, access node, road side unit (RSU), radio remote head (RRH), transmission point (TP), transmission and reception point (TRP), eNB, gNB, or the like.

Here, each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of things (IoT) device, mounted apparatus (e.g., a mounted module/device/terminal or an on-board device/terminal, etc.), or the like.

Hereinafter, HARQ feedback methods in a communication system will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

In order to improve reliability and efficiency in a communication system, a feedback transmission/reception scheme may be used. When a transmitting node of the communication system transmits a signal to a receiving node, the receiving node may transmit to the transmitting node a feedback indicating information on whether the signal transmitted from the transmitting node is normally received (i.e., whether the received signal is normally decoded). For example, in an exemplary embodiment of the communication system, the feedback transmission/reception scheme may be a HARQ feedback scheme.

When the HARQ feedback scheme is used, if the receiving node successfully decodes a first signal (e.g., data) received from the transmitting node, the receiving node may transmit a HARQ feedback indicating that the first signal is normally decoded to the transmitting node. Here, the HARQ feedback indicating that the first signal is normally decoded may correspond to acknowledgment (ACK). On the other hand, if the receiving node fails to decode the first signal received from the transmitting node, the receiving node may transmit a HARQ feedback indicating that the first signal is not normally decoded to the transmitting node. Here, the HARQ feedback indicating that the first signal is not normally decoded may correspond to negative-acknowledgement (NACK). When the transmitting node receives the NACK from the receiving node, the transmitting node may determine that the first signal is not normally received by the receiving node, and may perform an operation for retransmitting the first signal.

In an exemplary embodiment of the communication system, the receiving node may determine whether decoding is successful on a transport block (TB) basis. For example, if the receiving node fails to decode a TB constituting the first signal transmitted by the transmitting node or detect an error in a procedure of decoding the first signal, the receiving node may transmit a NACK for the TB. However, this is only an example for convenience of description, and exemplary embodiments of the present disclosure are not limited thereto. For example, the receiving node may determine whether decoding is successful on a code block (CB) basis with respect to the first signal received from the transmitting node. Alternatively, the receiving node may determine whether decoding is successful on a code block group (CBG) basis with respect to the first signal received from the transmitting node. Here, a CBG is a group consisting of at least one CB, and may be smaller than a TB and greater than or equal to a CB. If the receiving node fails to decode a portion of CBs constituting the first signal transmitted by the transmitting node or detect an error in a procedure of decoding the first signal, the receiving node may transmit a NACK for the portion of CBs. If the receiving node fails to decode a portion of CBGs constituting the first signal transmitted by the transmitting node or detect an error in a procedure of decoding the first signal, the receiving node may transmit a NACK for the portion of CBGs.

In an exemplary embodiment of the communication system, an upper node (e.g., base station) may perform downlink transmission to a lower node (e.g., terminal). The lower node may transmit a HARQ feedback to the upper node as a feedback for the downlink transmission from the upper node. Hereinafter, an exemplary embodiment of a HARQ feedback transmission/reception method will be described by taking as an example a situation in which a terminal performs HARQ feedback operations with respect to downlink data transmission performed by the base station for the terminal. However, this is only an example for convenience of description, and exemplary embodiments of the present disclosure are not limited thereto.

In an exemplary embodiment of the feedback transmission/reception method, a base station may transmit downlink data to a terminal on a physical downlink shared channel (PDSCH). The terminal may transmit a HARQ feedback for the downlink data received from the base station to the base station on a physical uplink control channel (PUCCH). Alternatively, the terminal may transmit the HARQ feedback for the downlink data received from the base station to the base station on a physical uplink shared channel (PUSCH). If the terminal succeeds in decoding the downlink data received from the base station, the terminal may transmit an ACK to the base station. On the other hand, if the terminal fails to decode the downlink data received from the base station, the terminal may transmit a NACK to the base station. When the base station receives the NACK from the terminal, the base station may determine that the downlink data transmitted to the terminal is not normally transmitted, and may retransmit the downlink data.

The base station may transmit a downlink control information (DCI) to the terminal on a physical downlink control channel (PDCCH) before transmitting the downlink data to the terminal on the PDSCH. The DCI transmitted by the base station to the terminal prior to the downlink data may be configured based on any one of DCI formats defined according to the 3GPP technical specifications. For example, the DCI transmitted by the base station to the terminal prior to the downlink data may be configured based on the DCI format 1_0, 1_1, 1_2, or the like. Alternatively, the DCI transmitted by the base station to the terminal prior to the downlink data may have a structure defined additionally to support exemplary embodiments of the feedback transmission/reception method according to the present disclosure. The DCI 1_0 format transmitted by the base station to the terminal prior to the downlink data may be configured to include some or all of the fields shown in Table 1. Also, the DCI 1_1 format may be configured to include some or all of the fields shown in Table 2.

TABLE 1

| Information Element (IE) | Size (bits) |
|---|---|
| Identifier for DCI formats | 1 |
| Frequency domain resource assignment | variable |
| Time domain resource assignment | 4 |
| VRB-to-PRB mapping | 1 |
| Modulation and coding scheme | 5 |
| New data indicator | 1 |
| Redundancy version | 2 |
| HARQ process number | 4 |
| Downlink assignment index | 2 |
| TPC command for scheduled PUCCH | 2 |
| PUCCH resource indicator | 2 |
| PDSCH-to-HARQ_feedback timing indicator | 3 |

TABLE 2

| Information Element (IE) | Size (bits) |
|---|---|
| Carrier indicator | 0, 3 |
| Identifier for DCI formats | 1 |
| Bandwidth part indicator | 0, 1, 2 |
| Frequency domain resource assignment | Variable according to a |
| | resource allocation type |
| Time domain resource assignment | 1, 2, 3, 4 |
| VRB-to-PRB mapping | 0, 1 |
| PRB bundling size indicator | 0, 1 |
| Rate matching indicator | 0, 1, 2 |
| ZP CSI-RS Trigger | 0, 1, 2 |
| Modulation and coding scheme [TB1] | 5 |
| New data indicator [TB1] | 1 |
| Redundancy version [TB1] | 2 |
| Modulation and coding scheme [TB2] | 5 |
| New data indicator [TB2] | 1 |
| Redundancy version [TB2] | 2 |
| HARQ process number | 4 |
| Downlink assignment index | 0, 4 |
| TPC command for scheduled PUCCH | 2 |
| PUCCH resource indicator | 3 |
| PDSCH-to-HARQ_feedback timing indicator | 3 |
| Antenna port(s) and number of layers | 4, 5, 6 |
| Transmission configuration indication | 0, 3 |
| SRS request | 2 |
| CBG transmission information | 0, 2, 4, 6, 8 |
| CBG flushing out information | 0, 1 |
| DMRS sequence initialization | 1 |

In Tables 1 and 2, the field ‘Identifier for DCI formats’ may indicate a DCI format. The field ‘Frequency domain resource assignment (FDRA)’ may indicate resource allocation information of a frequency region in which the downlink data is transmitted. The field ‘Time domain resource assignment (TDRA)’ may indicate resource allocation information of a time region in which the downlink data is transmitted. The field ‘Modulation and coding scheme (MCS)’ may indicate information related to a scheme in which the downlink data is modulated and encoded. The field ‘New data indicator (NDI)’ may indicate whether the downlink data is initially transmitted or retransmitted. The field ‘HARQ process number (HPN)’ may indicate a number(s) for at least one HARQ process. The field ‘Downlink assignment index (DAI)’ may indicate a data assignment number for a case where one ACK/NACK signal is transmitted for a plurality of data transmissions. That is, the field ‘DAI’ may indicate the number of PDSCHs transmitted within one slot. The field PUCCH resource indicator (PRI)′ may indicate information on a PUCCH resource to be used for a HARQ response. The field ‘PDSCH-to-HARQ feedback timing indicator’ may indicate information such as a time interval or the number of slots from a timing at which a PDSCH is transmitted to a timing at which a HARQ response for the PDSCH is transmitted.

The DCI transmitted by the base station to the terminal prior to the downlink data may be configured to include at least some of the fields shown in Table 1. In addition, the DCI transmitted by the base station to the terminal prior to the downlink data may be configured to include at least some of the fields shown in Table 2. The fields of the DCI that the base station transmits to the terminal prior to the downlink data may be configured to have the same or different sizes as those shown in Table 1. In addition, the fields of the DCI that the base station transmits to the terminal prior to the downlink data may be configured to have the same or different sizes as those shown in Table 2. The types of fields included in the DCI that the base station transmits to the terminal prior to the downlink data may be determined differently according to the format of the DCI. However, this is only an example for convenience of description, and exemplary embodiments of the present disclosure are not limited thereto.

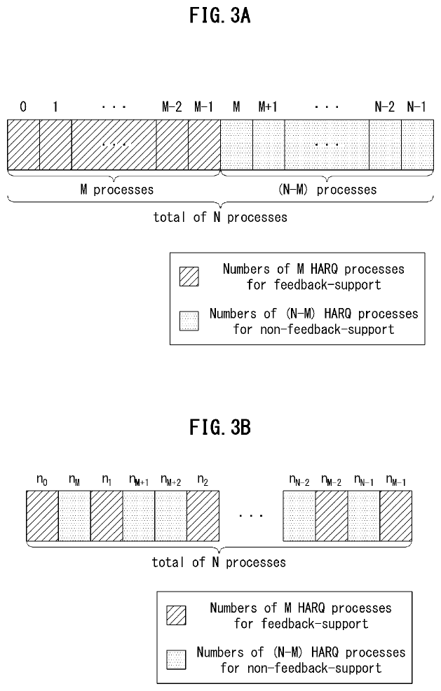

FIG. 3A is a conceptual diagram illustrating a first exemplary embodiment of HARQ processes for feedback-support or non-feedback-support in a communication system, and FIG. 3B is a conceptual diagram illustrating a second exemplary embodiment of HARQ processes for feedback-support or non-feedback-support in a communication system.

Referring to FIGS. 3A and 3B, the base station may extend the number of HARQ processes and the PDSCH-to-HARQ feedback timing field, and a transmission/reception method for supporting such the extension may vary depending on a HARQ process group.

A HARQ process for feedback-support, which supports HARQ feedback, may be referred to as a type 1-HARQ process. In addition, a HARQ process for non-feedback-support, which does not support HARQ feedback, may be referred to as a type 2-HARQ process. The base station may divide a plurality of HARQ processes into a HARQ process group for feedback-support, which includes a plurality of type 1-HARQ processes, and a HARQ process group for non-feedback-support, which includes a plurality of type 2-HARQ processes.

[Method of Consecutively Configuring HARQ Processes for Feedback-Support or Non-Feedback-Support]

Referring again to FIG. 3A, the base station may configure M HARQ processes (i.e., HARQ processes #0 to #(M−1)) among N HARQ processes as HARQ processes for feedback-support, and may configure the remaining (N−M) HARQ processes (i.e., HARQ processes #M to #(N−1)) as HARQ processes for non-feedback-support. The M HARQ processes that are HARQ processes for feedback-support may have consecutive numbers, and the (N−M) HARQ processes that are HARQ processes for non-feedback-support may have consecutive numbers.

When the M HARQ processes for feedback-support and the (N−M) HARQ processes for non-feedback-support belonging to the two HARQ process groups have consecutive numbers, respectively, the base station may transmit to the terminal information on the number M of the HARQ processes for feedback-support and information on a timing at which the value of M is applied through at least one of system information, higher layer message, medium access control (MAC) control element (CE), or DCI.

In addition, the base station may inform the terminal of the timing at which the value of M is applied, by using the number of slots (or subframes) from a timing at which the terminal receives the above-described signaling (i.e., at least one of system information, higher layer message, MAC CE, or DCI). The number of slots may indicate a slot offset. The terminal may receive from the base station the information on the number of M of the HARQ processes for feedback-support and the information on the timing at which the value of M is applied through the at least one of system information, higher layer message, MAC CE, or DCI.

In the above-described method, the base station may change the value of M according to a quality-of-service (QoS) level of the terminal. In another exemplary embodiment, the base station may set the value of M as the number of HARQ processes for non-feedback-support.

[Method of Non-Consecutively Configuring HARQ Processes for Feedback-Support or Non-Feedback-Support]

Referring back to FIG. 3B, the base station may configure M HARQ processes (i.e., HARQ processes #n₀ to #n_{M-1}) among N HARQ processes as HARQ processes for feedback-support, and may configure the remaining (N−M) HARQ processes (i.e., HARQ processes #n_{M} to #n_{N-1}) as HARQ processes for non-feedback-support. The M HARQ processes that are HARQ processes for feedback-support may have non-consecutive numbers, and the (N−M) HARQ processes that are HARQ processes for non-feedback-support may have non-consecutive numbers.

When the M HARQ processes for feedback-support and the (N−M) HARQ processes for non-feedback-support belonging to the two HARQ process groups have non-consecutive numbers, respectively, the base station may transmit to the terminal information on the numbers n₀, and n_{M-1} of the HARQ processes for feedback-support and information on a timing at which the process numbers are applied through at least one of system information, higher layer message, MAC CE, or DCI.

The base station may inform the terminal of the timing at which the corresponding HARQ processes are applied, by using the number of slots (or subframes) from a timing at which the terminal receives the above-described signaling (e.g., at least one of the information, higher layer message, MAC CE, or DCI). The number of slots may indicate a slot offset. The terminal may receive from the base station information on the numbers n₀, n₁, . . . , and n_{M-1} of the HARQ processes for feedback-support and information on the timing at which the process numbers are applied through the at least one of system information, higher layer message, MAC CE, or DCI.

The base station may define n₀, n₁, . . . , and n_{M-1} according to a specific configuration as shown in Table 3 below. Accordingly, the base station may reduce the amount of information transmitted to the terminal through at least one of system information, higher layer message, MAC CE, or DCI.

TABLE 3

| Configuration ID | Number of HARQ process for feedback-support |
|---|---|
| 0 | 0, 3, 6 |
| 1 | 0, 2, 5, 8 |
| 2 | 0, 5, |
| 3 | 4, 8, 16 |

In the above-described method of non-consecutively configuring the HARQ processes, the base station may extend the configurations of Table 3, and may change the value of M and n₀, n₁, . . . , and n_{M-1} according to a QoS level of the terminal. In addition, the base station may set the number of HARQ processes for feedback-support to be smaller than the number of HARQ processes for non-feedback-support for smooth HARQ operations in a wireless communication system having a long RTT.

[Method of Distinguishing a HARQ Process Group for Feedback-Support and a HARQ Process Group for Non-Feedback-Support]

The base station may configure the RV field included in DCI with a total of two bits, and through this, the base station may indicate four retransmission data versions. However, the base station may reduce the RV field for indicating the retransmission data version because the number of retransmissions may be very limited in case of a wireless communication system having a long RTT. Therefore, the base station may use one bit of the two bits of the RV field to indicate the HARQ process group for feedback-support or the HARQ process group for non-feedback-support instead of indicating the retransmission data version.

The base station may use one least significant bit (LSB) of the two bits of the RV field to distinguish between the HARQ process groups. The base station may set one LSB to a first value (e.g., 0) to indicate the HARQ process group for non-feedback-support, and set the one LSB to a second value (e.g., 1) to indicate the HARQ process group for feedback-support. The base station may transmit DCI including the RV field to the terminal. The terminal may receive the DCI including the RV field from the base station, and may interpret the value of the HPN field included in the DCI in association with the RV field. That is, when the one LSB is set to 0, the HPN field may indicate a HARQ process number of a HARQ process for non-feedback-support, and when the one LSB is set to 1, the HPN field may indicate a HARQ process number of a HARQ process for feedback-support. Accordingly, one most significant bit (MSB) of the two bits of the RV field may indicate the retransmission data version.

In the above-described method, the base station may configure the RV field such that the one LSB set to 0 indicates the HARQ process group for feedback-support, and the one LSB set to 1 indicates the HARQ process group for non-feedback-support.

In the above-described method, the base station may use one MSB of the two bits of the RV field to distinguish between the HARQ process groups, and may use one LSB thereof to indicate the retransmission data version.

[Method of Extending a PDSCH-to-HARQ Feedback Timing for Smooth Operations of HARQ Processes for Feedback-Support]

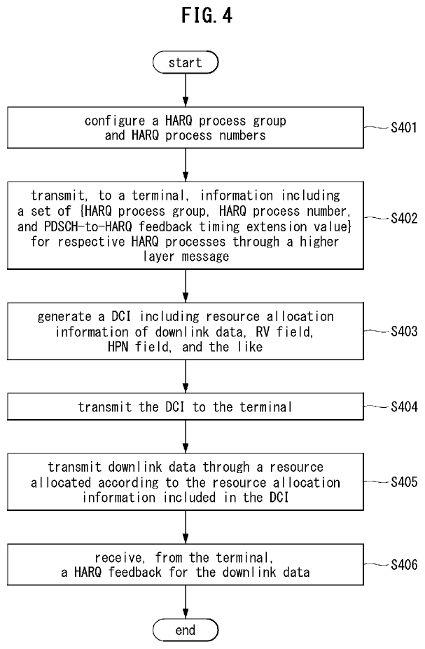

FIG. 4 is a flowchart illustrating a first exemplary embodiment of a feedback method in HARQ processes for feedback-support in a communication system.

Referring to FIG. 4, according to the above-described method (e.g., the method shown in FIG. 3A) of consecutively configuring the HARQ processes for feedback-support and the above-described method of non-consecutively configuring the HARQ processes for feedback-support (e.g., the method shown in FIG. 3B), the base station may configure the HARQ process group and the HARQ process numbers (S401). Then, the base station may transmit information including the HARQ process group and the HARQ process number for each of the total N HARQ processes to the terminal through at least one of system information, higher layer message, MAC CE, or DCI (S402). The terminal may receive from the base station the information including the HARQ process group and the HARQ process number for each of the N total HARQ processes through at least one of system information, higher layer message, MAC CE, or DCI.

The base station may generate a DCI for scheduling downlink data (S403). The DCI may include resource allocation information of the downlink data, an RV field, an HPN field, and the like. In the case of the HARQ process for feedback-support, the base station may configure the fields included in the DCI as follows. The base station may set one LSB of the RV field included in the control information to the second value (e.g., 1) by applying the above-described method for distinguishing between the HARQ process group for feedback-support and the HARQ process group for non-feedback-support, so that the one LSB of the RV field indicates the HARQ process group for feedback-support, and may use some bit(s) of the HPN field as an indicator of a HARQ process for feedback-support as follows.

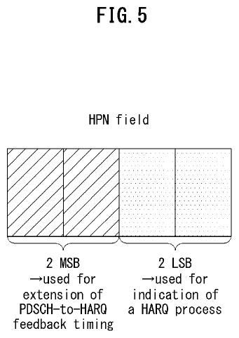

FIG. 5 is a conceptual diagram illustrating a method of using resources in an HPN field in a communication system.

Referring to FIG. 5, the HPN field may be configured with a total of 4 bits, and may indicate a total of 16 HARQ process numbers. In case of the HARQ process group for feedback-support, the HARQ process number may be interpreted differently according to the number of HARQ processes for feedback-support as follows.

As an exemplary embodiment of a method for using resources of the HPN field for feedback-support, when there are two HARQ processes for feedback-support, the base station may use one LSB of the HPN field as a HARQ process indicator for feedback-support. The HARQ process indicator for feedback-support may indicate the first HARQ process number in the HARQ process group for feedback-support when the LSB is set to 0, and may indicate the second HARQ process number in the HARQ process group for feedback-support when the LSB is set to 1. The base station may use three MSBs of the HPN field to indicate extension of the PDSCH-to-HARQ feedback timing, various target block error rates (BLERs), and/or MCS.

As another exemplary embodiment, when there are four HARQ processes for feedback-support, the base station may use two LSBs of the 4-bit HPN field as the HARQ process indicator for feedback-support. The HARQ process indicator for feedback-support may indicate the first HARQ process number in the HARQ process group for feedback-support when the two LSBs are set to ‘00’, may indicate the second HARQ process number in the HARQ process group for feedback-support when the two LSBs are set to ‘01’, may indicate the third HARQ process number in the HARQ process group for feedback-support when the two LSBs are set to ‘10’, and may indicate the fourth HARQ process number in the HARQ process group for feedback-support when the two LSBs are set to ‘11’. The base station may use two MSBs of the HPN field to indicate extension of the PDSCH-to-HARQ feedback timing and various target BLERs or MCSs.

As in the above-described method, the base station may use some bit(s) of the HPN field as the HARQ process indicator. In addition, the terminal may know the number of bits used as the HARQ process indicator through the number of HARQ processes.

In the above-described method, the base station may use the remaining bits (i.e., three MSBs in the first exemplary embodiment, and two MSBs in the second exemplary embodiment) of the HPN field as a timing value for extending the PDSCH-to-HARQ feedback timing. The timing value may be set in units slots. That is, when the base station uses two MSBs to indicate an extended value of the PDSCH-to-HARQ feedback timing, the two MSBs set to ‘00’ may indicate 8 slots, the two MSBs set to ‘01’ may indicate 12 slots, the two MSBs set to ‘10’ may indicate 16 slots, and the two MSBs set to ‘11’ may indicate 20 slots. The corresponding value may be used by being added to the conventional PDSCH-to-HARQ feedback timing value (S405).

The base station may transmit a set of the feedback timing extension values according to the MSB(s) to the terminal together with the above-described information on the HARQ processes through at least one of system information, higher layer message, MAC CE or DCI. As described above, the set may be defined differently according to the number of HARQ processes for feedback-support. The base station may use the remaining bits of the HPN field to indicate various target BLERs or MCSs in addition to the extension of the PDSCH-to-HARQ feedback timing. In the above-described method, the base station may replace the LSB(s) to be used as the HARQ process indicator for feedback-support with the MSB(s).

The base station may transmit the DCI including the RV field and the HPN field configured as described above to the terminal (S404). The terminal may receive the DCI including the RV field and the HPN field configured by the base station from the base station. The base station may transmit downlink data to the terminal through a resource allocated according to the resource allocation information included in the DCI (S405). The terminal may receive the downlink data from the base station. In addition, when the information included in the DCI received from the base station indicates a HARQ process for feedback-support, the terminal may transmit a HARQ feedback for the downlink data to the base station. The base station may receive the HARQ feedback for the downlink data from the terminal (S406).

[Method of Extending HARQ Processes for Non-Feedback-Support]

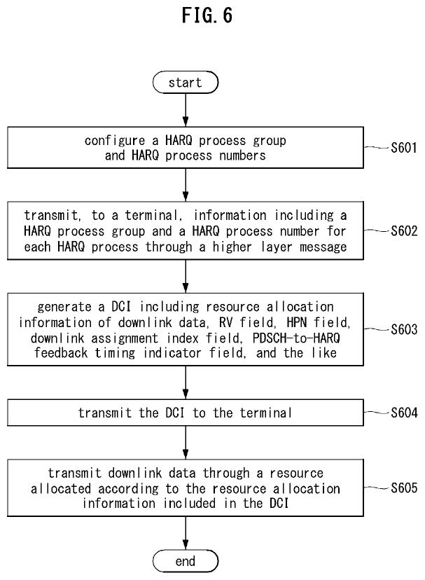

FIG. 6 is a flowchart illustrating a first exemplary embodiment of a feedback method in HARQ processes for non-feedback-support in a communication system.

Referring to FIG. 6, according to the above-described method (e.g., the method shown in FIG. 3A) of consecutively configuring the HARQ processes for feedback-support and the above-described method of non-consecutively configuring the HARQ processes for feedback-support (e.g., the method shown in FIG. 3B), the base station may configure the HARQ process group and the HARQ process numbers (S601). Then, the base station may transmit information including the HARQ process group and the HARQ process number of each of the total N HARQ processes to the terminal through at least one of system information, higher layer message, MAC CE, or DCI (S602). The terminal may receive from the base station the information including the HARQ process group and the HARQ process number of each of the N total HARQ processes through at least one of system information, higher layer message, MAC CE, or DCI.

The base station may generate a DCI for scheduling downlink data (S603). The DCI may include resource allocation information of the downlink data, an RV field, a HPN field, a DAI field, a PDSCH-to-HARQ feedback timing indicator field, and the like. In case of the HARQ process for non-feedback-support, the base station may set fields included in the DCI as follows. The base station may set one LSB of the RV field included in the control information to the first value (e.g., 0) to indicate the HARQ process group for non-feedback-support, by applying the above-described method of distinguishing the HARQ process group for feedback-support and the HARQ process group for non-feedback-support. In addition, the base station may use a total of 4 bits of the HPN field as a HARQ process indicator for non-feedback-support.

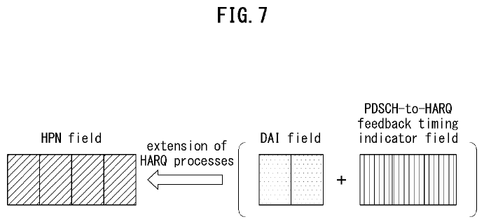

FIG. 7 is a conceptual diagram illustrating a method of extending HARQ processes in a communication system.

Referring to FIG. 7, in case of the HARQ process for non-feedback-support, the terminal may not transmit a HARQ feedback for downlink data to the base station. Therefore, since the base station may not use the DAI field and the PDSCH-to-HARQ feedback timing indicator field for HARQ feedback, which are included in the DCI, the base station may use the DAI field and the PDSCH-to-HARQ feedback timing indicator field for other purposes. When the number of HARQ processes for non-feedback-support is greater than 16, the base station may use the DAI field composed of two bits for extending the number of HARQ processes. Alternatively, the base station may use the DAI field to indicate various target BLERs or MCSs. The base station may use the PDSCH-to-HARQ feedback timing indicator field composed of 3 bits for the same purpose as the above-mentioned purpose.

The base station may transmit the DCI including the RV field, the HPN field, the DAI field, the PDSCH-to-HARQ feedback timing indicator field, and the like configured as described above to the terminal (S604). The terminal may receive the DCI including the RV field, the HPN field, the DAI field, and the PDSCH-to-HARQ feedback timing indicator field configured by the base station from the base station. The base station may transmit downlink data to the terminal through a resource allocated according to the resource allocation information included in the DCI (S605). The terminal may receive the downlink data from the base station. In addition, when the information included in the DCI received from the base station indicates the HARQ process for non-feedback-support, the terminal may not transmit a HARQ feedback for the downlink data to the base station.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the exemplary embodiments of the present disclosure and their advantages have been described in detail, it should be understood that various changes, substitutions and alterations may be made herein without departing from the scope of the present disclosure.

What is claimed is:

1. An operation method of a terminal in a communication system, the operation method comprising:
receiving, from a base station, a higher layer message including first configuration information of a first hybrid automatic repeat request (HARQ) process group and second configuration information of a second HARQ process group;
receiving, from the base station, control information including a redundancy version (RV) field including first information indicating one HARQ process group used for communication between the terminal and the base station among the first HARQ process group and the second HARQ process group, a HARQ process number (HPN) field including second information indicating a number of a HARQ process belonging to the one HARQ process group indicated by the first information, and resource allocation information;
receiving data from the base station based on the resource allocation information; and
determining whether to transmit a HARQ feedback for the data according to the first information included in the control information,
wherein the first HARQ process group includes a plurality of type 1-HARQ processes for feedback-support, and the second HARQ process group includes a plurality of type 2-HARQ processes for non-feedback-support.

2. The operation method according to claim 1, wherein the first configuration information includes information on the first HARQ process group to which the plurality of type 1-HARQ processes belong, and HARQ process numbers set to the plurality of type 1-HARQ processes.

3. The operation method according to claim 1, wherein the second configuration information includes information on the second HARQ process group to which the plurality of type 2-HARQ processes belong, and HARQ process numbers set to the plurality of type 2-HARQ processes.

4. The operation method according to claim 1, wherein when the first information included in the RV field indicates the first HARQ process group, the HPN field further includes an extension value of a physical downlink shared channel (PDSCH)-to-HARQ feedback timing.

5. The operation method according to claim 1, wherein when the second information included in the HPN field indicates a number of one of the plurality of type 2-HARQ processes belonging to the second HARQ process group, the control information further includes a downlink assignment index (DAI) field and a PDSCH-to-HARQ feedback timing indicator field, and the DAI field and the PDSCH-to-HARQ feedback timing indicator field are used for extension of HARQ processes.

6. The operation method according to claim 1, further comprising performing an operation of transmitting the HARQ feedback to the base station according to information indicated by the first information,
wherein when the first information indicates the first HARQ process group, the operation of transmitting the HARQ feedback is performed, and when the first information indicates the second HARQ process group, the operation of transmitting the HARQ feedback is not performed.

7. An operation method of a base station in a communication system, the operation method comprising:
configuring a first hybrid automatic repeat request (HARQ) process group including a plurality of type 1-HARQ processes and a second HARQ process group including a plurality of type 2-HARQ processes;
transmitting, to a terminal, a higher layer message including first configuration information of the first HARQ process group and second configuration information of the second HARQ process group;
transmitting, to the terminal, control information including a redundancy version (RV) field including first information indicating one HARQ process group used for communication between the terminal and the base station among the first HARQ process group and the second HARQ process group, a HARQ process number (HPN) field including second information indicating a number of a HARQ process belonging to the one HARQ process group indicated by the first information, and resource allocation information; and
transmitting data to the terminal based on the control information,
wherein the first HARQ process group includes a plurality of type 1-HARQ processes for feedback-support, and the second HARQ process group includes a plurality of type 2-HARQ processes for non-feedback-support.

8. The operation method according to claim 7, wherein the first configuration information includes information on the first HARQ process group to which the plurality of type 1-HARQ processes belong, and HARQ process numbers set to the plurality of type 1-HARQ processes.

9. The operation method according to claim 7, wherein the second configuration information includes information on the second HARQ process group to which the plurality of type 2-HARQ processes belong, and HARQ process numbers set to the plurality of type 2-HARQ processes.

10. The operation method according to claim 7, wherein when the first information included in the RV field indicates the first HARQ process group, the HPN field further includes an extension value of a physical downlink shared channel (PDSCH)-to-HARQ feedback timing.

11. The operation method according to claim 7, wherein when the second information included in the HPN field indicates a number of one of the plurality of type 2-HARQ processes belonging to the second HARQ process group, the control information further includes a downlink assignment index (DAI) field and a PDSCH-to-HARQ feedback timing indicator field, and the DAI field and the PDSCH-to-HARQ feedback timing indicator field are used for extension of HARQ processes.

12. The operation method according to claim 7, further comprising performing an operation of receiving the HARQ feedback for the data from the base station according to information indicated by the first information,
wherein when the first information indicates the first HARQ process group, the operation of receiving the HARQ feedback is performed, and when the first information indicates the second HARQ process group, the operation of receiving the HARQ feedback is not performed.

13. A terminal in a communication system, the terminal comprising:
a processor;
a memory electronically communicating with the processor; and
instructions stored in the memory,
wherein when executed by the processor, the instructions cause the terminal to:
receive, from a base station, a higher layer message including first configuration information of a first hybrid automatic repeat request (HARQ) process group and second configuration information of a second HARQ process group;
receive, from the base station, control information including a redundancy version (RV) field including first information indicating one HARQ process group used for communication between the terminal and the base station among the first HARQ process group and the second HARQ process group, a HARQ process number (HPN) field including second information indicating a number of a HARQ process belonging to the one HARQ process group indicated by the first information, and resource allocation information;
receive data from the base station based on the resource allocation information; and
determine whether to transmit a HARQ feedback for the data according to the first information included in the control information,
wherein the first HARQ process group includes a plurality of type 1-HARQ processes for feedback-support, and the second HARQ process group includes a plurality of type 2-HARQ processes for non-feedback-support.

14. The terminal according to claim 13, wherein the first configuration information includes information on the first HARQ process group to which the plurality of type 1-HARQ processes belong, and HARQ process numbers set to the plurality of type 1-HARQ processes.

15. The terminal according to claim 13, wherein the second configuration information includes information on the second HARQ process group to which the plurality of type 2-HARQ processes belong, and HARQ process numbers set to the plurality of type 2-HARQ processes.

16. The terminal according to claim 13, wherein when the first information included in the RV field indicates the first HARQ process group, the HPN field further includes an extension value of a physical downlink shared channel (PDSCH)-to-HARQ feedback timing.

17. The terminal according to claim 13, wherein when the second information included in the HPN field indicates a number of one of the plurality of type 2-HARQ processes belonging to the second HARQ process group, the control information further includes a downlink assignment index (DAI) field and a PDSCH-to-HARQ feedback timing indicator field, and the DAI field and the PDSCH-to-HARQ feedback timing indicator field are used for extension of HARQ processes.

18. The terminal according to claim 13, wherein the instructions further cause the terminal to: perform an operation of transmitting the HARQ feedback to the base station according to information indicated by the first information, wherein when the first information indicates the first HARQ process group, the operation of transmitting the HARQ feedback is performed, and when the first information indicates the second HARQ process group, the operation of transmitting the HARQ feedback is not performed.
